(19) United States
(12) Patent Application Publication
(10) Pub. No.: US 2005/0109154 A1
(43) Pub. Date: May 26, 2005

(54) Anti-vibration apparatus and related method thereof for rotating disks

(76) Inventor: Sean Chang, Taoyuan Hsien (TW)

Correspondence Address: BIRCH STEWART KOLASCH & BIRCH, PO BOX 747, FALLS CHURCH, VA, 22040-0747, US

(21) Appl. No.: 10/791,818

(22) Filed: Mar. 4, 2004

(30) Foreign Application Priority Data
Nov. 20, 2003 (TW) 092132495

(51) Int. Cl. F16F 15/22

(52) U.S. Cl. 74/573 R

(57) ABSTRACT

An anti-vibration apparatus and related method used in an image display system for rotating disks. It effectively eliminates vibration of a rotating disk due to unbalance. The method is to fill curable fluid and a plurality of spheres in a holder of the rotating disk. When the disk rotates, the unbalance force will drive the disk to create vibration displacement, and the displacement will drive the plurality of spheres to corresponding balance positions of the rotating disk. To harden the fluid so that the plurality of spheres are positioned at the balance positions of the rotating disk. As a result, the present invention can effectively eliminate vibration of a rotating disk, such as a color wheel module.

### BACKGROUND OF THE INVENTION

1. Field of the Invention

The present invention relates to an anti-vibration apparatus and related method thereof for use in a rotating disk of an image display system, and more specifically, to a method and apparatus that utilizes curable fluid and a plurality of spheres to eliminate vibration generated by a rotating disk.

2. Description of the Prior Art

In theory, a rotating disk may rotate about the rotational spindle in a steady and balanced manner. However, in practice, due to inherent manufacturing defects or assembly problems, the substance of the rotating disk does not evenly distribute. As a result, vibration occurs when the rotating disk rotates. Although the vibration amplitude might not be significant in some circumstances, with precise optical instruments it becomes a critical factor whether the required precision level can be achieved.

Take the color wheel module, which has been widely used in image display devices as disclosed in U.S. Pat. No. 5,868,482, for example. The color wheel includes a plurality of color filter films bonding together. Its rotation modulates the color of the incident light to provide light beams with the sequential color changed at a rapid frequency so that the image display device can produce the required image formation. As the color wheel switches the color of the incident light through rotation, balance becomes an important issue.

Conventional balance methods mostly try to determine the unbalanced location through actually driving a disk 11. As shown in FIGS. 1A and 1B, the disk 11 is driven to rotate by a motor 12. Because the unbalance substance M of the disk 11 generates a centrifugal force during rotating, the centrifugal force incurs vibration. A sensor, such as an accelerometer, may be used to detect the amplitude and phase angle of the vibration generated by the rotating disk 11. Based on the vibration amplitude and phase angle, the unbalance substance M and its phase angle θ may be determined. Moreover, in order to avoid interference caused by the mounting plane such as the table top which the disk 11 is driven, the disk 11 and the motor 12 may be mounted onto a suspending surface 13 supported by springs 14.

When the unbalance substance M and the phase angle of the disk 11 are known, there are two common approaches to remedy the problem, i.e. adding or removing the corresponding substance. Manufacturers may choose to add a corresponding substance on location 180 degrees against the unbalance substance M to eliminate the vibration. It is also possible to remove a corresponding substance on the location of the unbalance substance M to eliminate the vibration. However, in practice, the location and amount of the unbalance substance M cannot be calculated as accurately as desired. In most circumstances, only proximate values are obtained. Then trial and error approaches are taken to perform correction. For instance, a drill out method may be taken to remove the substance. When the unbalance substance M of the disk 11 is obtained, a small hole maybe drilled on the location where the unbalance substance M is positioned to remove a selected amount of substance. Then a test run is taken. If the result is not satisfactory, another small hole is drilled. In the event that too many holes are drilled on one side, a small hole is drilled on the diagonal side. The process is repeatedly performed until the disk 11 is balanced. Such a balance method is inefficient. Even the final balance attained is not totally desirable. It can only reach a balance within the range of tolerances of measurement and calculation.

### SUMMARY OF THE INVENTION

It is therefore a primary objective of the present invention to provide an anti-vibration apparatus and related methods thereof used in a rotating disk of an image display system for solving aforementioned problems.

The present invention discloses an anti-vibration apparatus and related method thereof applied in an image display system for eliminating vibration generated by a rotating disk. The present method is to fill a selected amount of curable fluid and a plurality of spheres in a holder after the holder is formed on the rotating disk. When the rotating disk rotates, unbalance of the rotating disk will generate some vibration force and that vibration force will drive the fluid and spheres moving, so that the fluid and the plurality of spheres will automatically flow to and distribute on balanced positions due to the vibration force. Finally, the fluid is curdled and solidified so as to fix the plurality of spheres position. Thus, balance can be reached for the rotating disk.

It is an advantage of the present invention that the flowage of the fluid and the plurality of spheres is done due to the vibration so that the fluid and the spheres will keep floating until the vibration is gone. Such a method and apparatus is not only easier to implement, it also can attain more precise balance.

These and other objectives and advantages of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic view of a structure for measuring unbalance conditions of a rotating disk according to the prior art.

FIG. 1B is a schematic view of a rotating disk under an unbalance condition according to the prior art.

FIG. 2A, 2B and 2C are schematic views showing the automatic balance principle according to the present invention.

FIGS. 3A to 3D are schematic views showing balance processes according to the present invention.

FIGS. 4A to 4D are schematic views showing a holder of the rotating disk according to the present invention.

FIG. 5 is a schematic view of a structure for measuring unbalance conditions of the rotating disk according to the present invention.

FIGS. 6A and 6B are schematic views applied in a color wheel module according to the present invention.

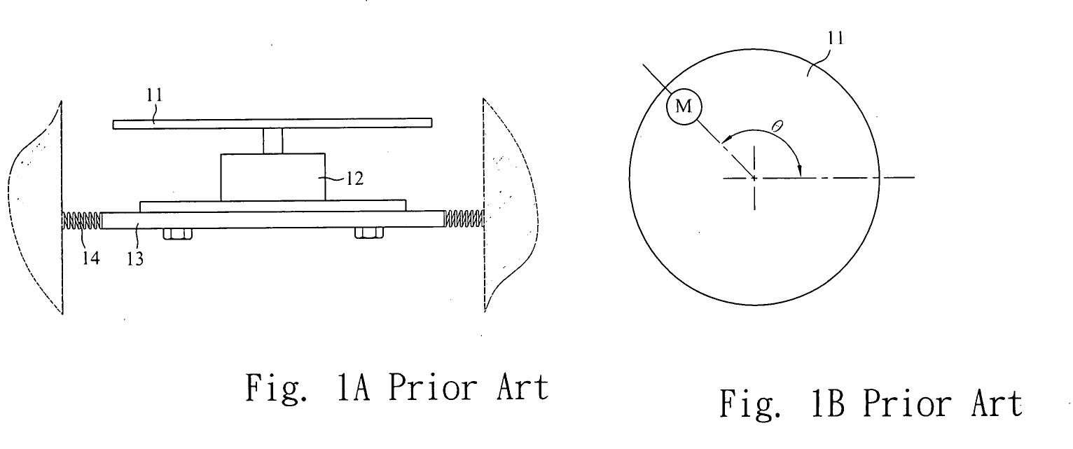

### DETAILED DESCRIPTION OF THE PREFERRED EMBODIMENTS

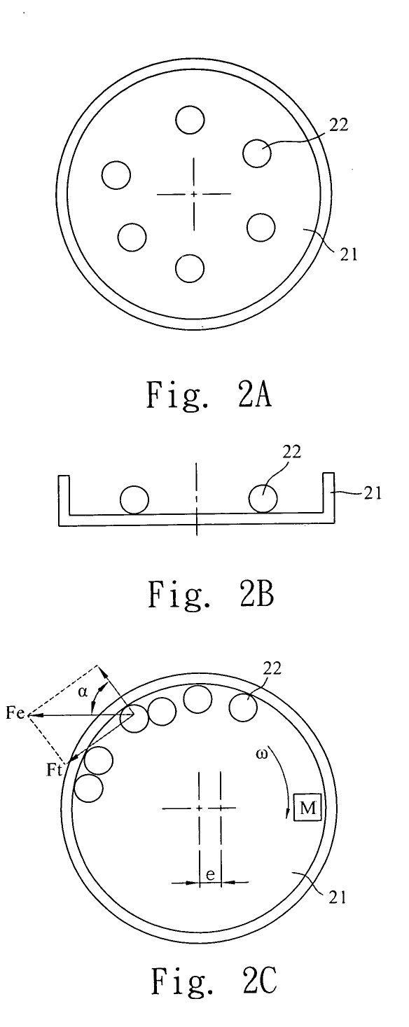

Please refer to FIGS. 2A to 2C. FIG. 2A to 2C are schematic views showing the automatic balance principle according to the present invention. The anti-vibration apparatus and related methods thereof are especially adopted for use on color wheel modules and rotating disks of an image display system for eliminating vibration. As shown in FIGS. 2A to 2C, there is a container 21 with an unbalance substance M. The container 21 further holds a plurality of steel balls 22. When the container 21 rotates at a selected angular speed ω, the unbalance substance M incurs a vibration displacement e due to the centrifugal force. The vibration displacement e generates a force Fe (Fe=me ω², where m is the substance of the steel balls) on the steel balls 22. The component force Ft (Ft=Fe * cos (α), where α is the included angle against the radial direction) of the force Fe in the tangential direction moves the steel balls 22 along the perimeter direction opposite to the unbalance substance M until reaching a balance condition. As fluid does not have enough quality for equilibrium, the curable fluid with a selected amount of steel balls can replace that only place the steel balls 22 in the container 21 to attain a completed balance condition. Therefore, the purpose of filling the fluid within the container is to reduce the friction between steel balls and the container and to fix the steel balls position after it is curdled.

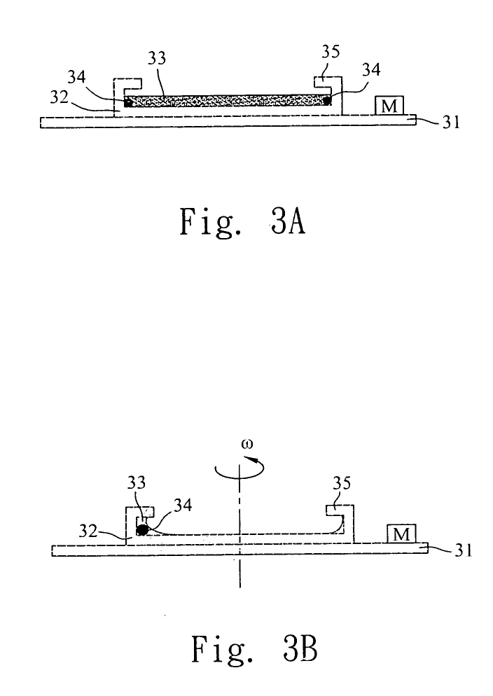

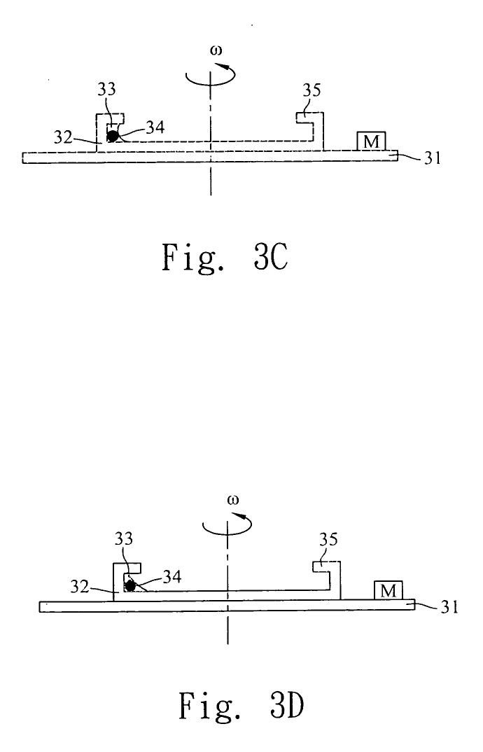

Please refer to FIGS. 3A to 3D, which adopts the principle set forth above according to the present invention. As shown in FIGS. 3A to 3D, the present invention utilizes a rotating disk 31 with a bowl 32 located thereon to form a holder. Then, to measure an unbalance substance M located on one side of the rotating disk 31 by a vibration measuring device (not shown) so as to place a plurality of spheres 34 in the holder of the rotating disk 31. Afterwards, to fill a selected amount of a curable fluid 33 and place the predetermined amount of spheres 34 within the holder under a motionless state for compensating the unbalance substance M. It needs to be noted that the spheres 34 used in the preferred embodiment of the present invention are made of metal, such as steel balls. Furthermore, the spheres 34 may be replaced by metalloid spheres, such as ceramic balls, having the same mass as the metallic spheres.

Accordingly, to put the rotating disk 31 on the vibration measuring device. When the rotating disk 31 rotates, the fluid 33 and the predetermined amount of spheres 34 are subject to the vibration force generated by the rotating disk 31 with the unbalance substance M, and flow along the perimeter direction to the other side but will be held in the holder due to the constraint of the side wall of the holder as shown in FIG. 3B. Take FIG. 3C for example, the unbalance substance M is located on the right side, so the fluid 33 and the spheres 34 finally accumulate on the left side of the bowl 32. In an ideal condition, the position distribution of the fluid 33 and the spheres 34 will compensate the unbalance substance M as shown in FIG. 3C. However, due to viscosity, surface tension, and centrifugal force, the actual fluid distribution is like that shown in FIG. 3D. In such a condition, the spheres 34 and the fluid 33 accumulated on the left side of the rotating disk 31 offset the unbalance substance M on the right side of the rotating disk 31. Therefore, the rotating disk 31 reaches a balance condition, and the unbalance due to vibration can be prevented.

Because the vibration force will always existent when there is an unbalance in the rotating disk 31, so the fluid 33 and spheres 34 will keep moving until the rotating disk is well balanced. Once the balance condition is attained, the fluid 33 is curdled and solidified, and the spheres 34 are also positioned, simultaneously. The distributed state may be fixed to maintain a-permanent balance condition.

Since the spheres 34 can move automatically to be distributed at the corresponding balance positions of the rotating disk 31, distribution of the fluid 33 and the spheres 34 offsets the unbalance substance M of the rotating disk 31. The present invention not only saves the time of the trial and error process, but the balance condition is also more precise.

Moreover, the curable fluid 33 may be selected from photosensitive curable fluid (such as UV gel), thermal sensitive curable fluid, or double agent curable gel. The curing process of the fluid 33 may be done by providing photo energy, thermal energy, catalysts, or the like. It needs to be noted that the curable fluids and curing methods mentioned above are only to serve as examples; other types of curable fluid may also be selected as desired.

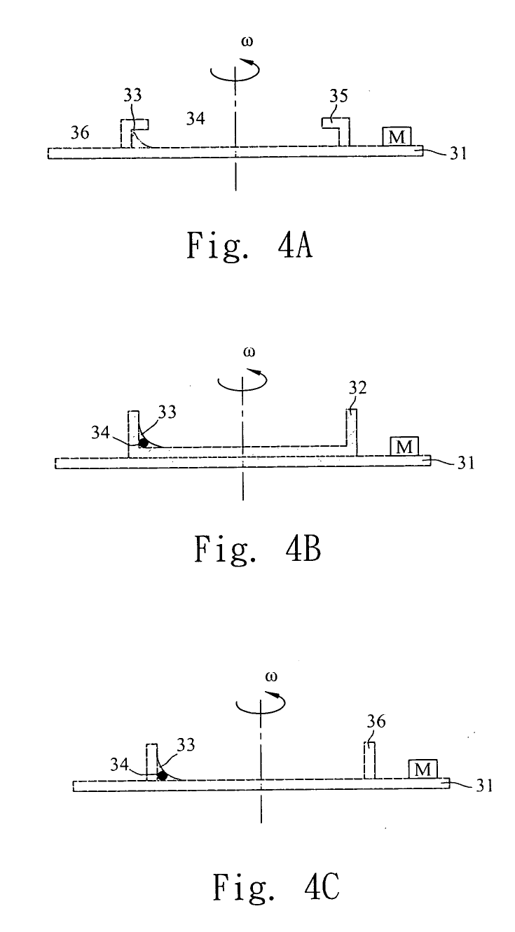

FIG. 3A illustrates an embodiment of the holder that is formed by mounting a bowl 32 onto a rotating disk 31. The mounting process can be accomplished by adhering, screwing, coupling, latching, or other fastening means known in the prior art. In order to prevent the fluid 33 from spilling out during rotating, an extended flange 35 may be formed on the top edge of the side wall of the bowl 32. Of course, an annular element 36 may also be used as shown in FIG. 4A to mount onto the rotating disk 31 to form the holder on the rotating disk 31 so as to contain the fluid 33 and the spheres 34. On the other hand, when the amount of the fluid 33 is not much, or the bowl 32 and the annular element 36 have a higher side wall, the extended flange may be dispensed as shown in FIG. 4B and FIG. 4C.

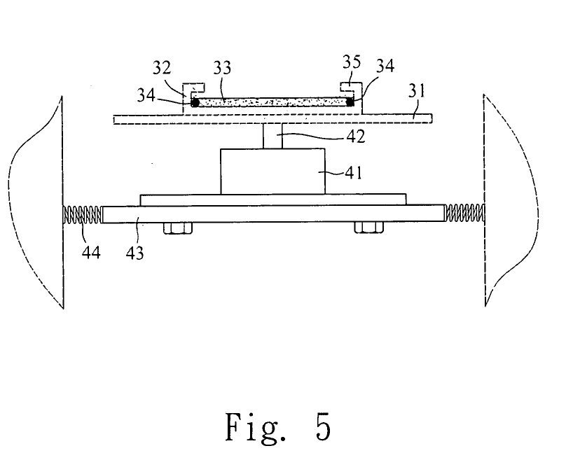

For performing balance in practical situations, the rotating disk 31 may be mounted onto a spindle 42 of a motor 41 and driven to rotate. Similarly, in order to prevent interference or inaccurate measuring, a suspending board 43 supported by springs 44 may be used to anchor the whole structure as shown in FIG. 5.

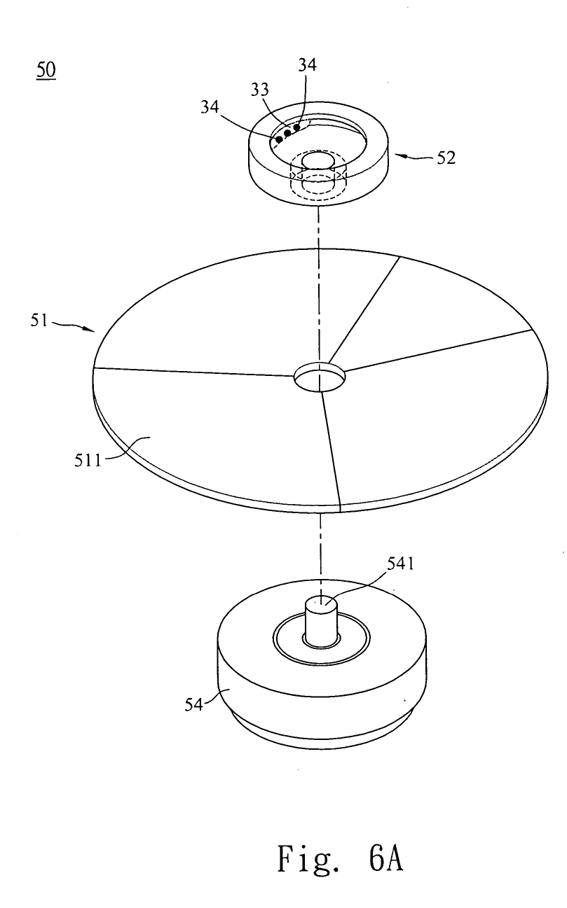

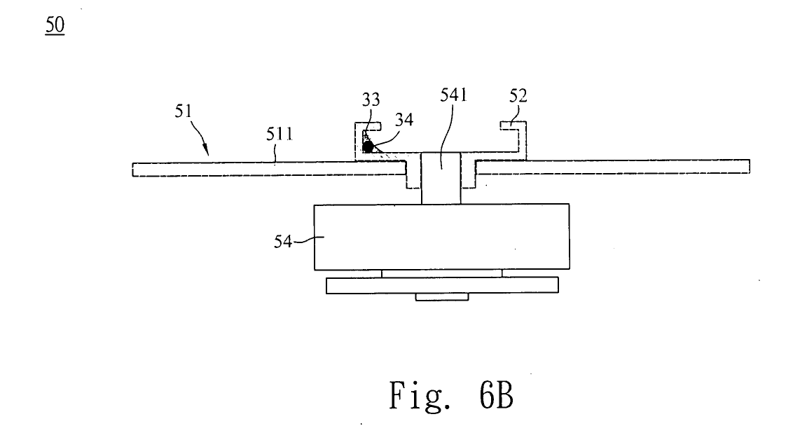

Please refer FIGS. 6A and 6B. FIGS. 6A and 6B are schematic views applied in a color wheel module 50 according to the present invention. The color wheel module 50 includes a motor 54, a spindle 541, a holder 52, and a color wheel 51. The motor 54 drives the spindle 541 to rotate. The holder 52 is formed on the inner peripheral rim of the color wheel 51 and is coaxial with the color wheel 51. Moreover, the holder 52 and the color wheel 51 are coupled together and are tightly mounted onto the spindle 541 so as to be driven by the motor 54 for rotating.

The holder 52 is bonded to the inner peripheral rim of the color wheel 51. The bonding method may be direct adhesion or the like. The holder 52 may be formed in any one of the embodiments set forth above (bowl, annular element, etc.) to contain the curable fluid 33 and the spheres 34. In addition, the color wheel 51 includes a plurality of transparent color filter films 511 for modulating and changing the color of the light beams passing through. The color filter films 511 mostly have red, green, blue and white colors. They are respectively formed in a fan-shape to couple together for forming the circular color wheel 51.

Once the holder 52 is bonded to the color wheel 51, balance may be performed independently. Balance may be achieved by the method set forth above, and by means of the apparatus shown in FIG. 5. After balance is attained, the holder 52 is mounted onto the spindle 541, which is driven by the motor 54 to modulate the color of the light beams alternately. On the other hand, it is also allowable to mount the holder 52 and the color wheel 51 on the spindle 541, then to perform balance and curing process. This may be done because fluid curing process does not affect the original precision after balance is achieved.

In contrast to the prior art, the present anti-vibration apparatus and related method thereof for use in a rotating disk of an image display system employs fluid and a plurality of spheres with a selected amount of mass and quantities to be distributed at balance positions under high speed rotation. Furthermore, the present invention utilizes the curing characteristics to solidify the fluid. Thus balance is easier to achieve and more precise.

Those skilled in the art will readily observe that numerous modifications and alterations of the device may be made while retaining the teachings of the invention. Accordingly, the above disclosure should be construed as limited only by the metes and bounds of the appended claims.

1. An anti-vibration method applied in a rotating disk of an image display system for eliminating unbalance of the rotating disk, comprising steps of:
forming a holder on the rotating disk;
filling a selected amount of a curable fluid and a plurality of spheres in the holder;
rotating the rotating disk until the rotating disk reaching balance; and
curing the curable fluid.

2. The anti-vibration method of claim 1, wherein the holder is formed by an annular element or a bowl bonding to the rotating disk.

3. The anti-vibration method of claim 2, wherein the annular element or the bowl is bonded by a means selected from a group consisting of adhering, screwing, latching and coupling.

4. The anti-vibration method of claim 1, wherein the curing of the curable fluid is selected from a group of approaches consisting of providing photo energy, providing thermal energy and providing catalysts.

5. The anti-vibration method of claim 4, wherein the curable fluid is selected from a group of fluid consisting of a photosensitive curable fluid, a thermal sensitive curable fluid and a double agent curable gel.

6. The anti-vibration method of claim 1, wherein the holder and the rotating disk are coaxial.

7. The anti-vibration method of claim 1 further comprising a step of:
measuring an unbalance amount of the rotating disk by a measuring device for selecting a predetermined amount of the spheres to be placed within the holder of the rotating disk.

8. An anti-vibration apparatus applied in a rotating disk of an image display system for eliminating unbalance of the rotating disk , comprising:
a motor for providing rotation power;
a spindle housed in the motor and coupled with the rotating disk for transmitting the rotation power to drive the rotating disk;
a holder formed on the rotating disk;
a curable fluid contained in the holder; and
a predetermined amount of spheres placed in the holder;
wherein when the motor drives the rotating disk to rotate, the fluid and the spheres filled within the holder of the rotating disk are naturally flowed to the periphery side of the holder under a vibration force and distributed in such a way to balance the rotating disk, and the fluid is then cured after the balance of the rotating disk is attained.

9. The anti-vibration apparatus of claim 8, wherein the holder is formed by an annular element or a bowl bonding to the rotating disk.

10. The anti-vibration apparatus of claim 9, wherein the annular element or the bowl is bonded by a means selected from a group consisting of adhering, screwing, latching and coupling.

11. The anti-vibration apparatus of claim 8, wherein the curable fluid is selected from a group of fluid consisting of a photosensitive curable fluid, a thermal sensitive curable fluid and a double agent curable gel.

12. The anti-vibration apparatus of claim 8, wherein the holder has a flange located on a top end of a side wall thereof and extended inwards.

13. The anti-vibration apparatus of claim 8, wherein the holder and the rotating disk are coaxial.

14. The anti-vibration apparatus of claim 8, wherein the sphere is made of metal.

15. The anti-vibration apparatus of claim 8, wherein the sphere is made of metalloid.

16. A color wheel module applied in an image display system for modulating the color of an incident light, comprising:
a motor for providing rotation power;
a disc-shaped color filter disk with a plurality of thin film color filters being driven to rotate by the motor for alternately modulating the color of the incident light;
a holder formed on inner periphery of the disc-shaped color filter disk;
a curable fluid contained in the holder; and
a plurality of spheres placed in the holder;
wherein when the motor drives the disc-shaped color filter disk to rotate, the fluid and the spheres filled within the holder of the color wheel are naturally flowed to the periphery side of the holder under a vibration force and distributed in such a way to balance the disc-shaped color filter disk, and the fluid is then cured after the balance of the color wheel module is attained.

17. The color wheel module of claim 16, wherein the holder is formed by an annular element or a bowl bonding to the color wheel module.

18. The color wheel module of claim 17, wherein the annular element or the bowl is bonded by a means selected from a group consisting of adhering, screwing, latching and coupling.

19. The color wheel module of claim 16, wherein the curable fluid is selected from a group of fluid consisting of a photosensitive curable fluid, a thermal sensitive curable fluid and a double agent curable gel.

20. The color wheel module of claim 16, wherein the holder has a flange located on a top end of a side wall thereof and extended inwards.

21. The color wheel module of claim 16, wherein the holder and the color wheel are coaxial.

22. The color wheel module of claim 16, wherein the sphere is made of metal.

23. The color wheel module of claim 16, wherein the sphere is made of metalloid.
